(19) United States
(12) Patent Application Publication
(10) Pub. No.: US 2013/0207382 A1
(43) Pub. Date: Aug. 15, 2013

(54) Connection Assembly for Tubular Goods and Accessories

(71) Applicant: PREMIERE, INC., (US)

(72) Inventor: Lee M. Robichaux, Lafayette, LA (US)

(73) Assignee: PREMIERE, INC., New Iberia, LA (US)

(21) Appl. No.: 13/760,237

(22) Filed: Feb. 6, 2013

Related U.S. Application Data
(60) Provisional application No. 61/595,966, filed on Feb. 7, 2012.

(51) Int. Cl. F16L 17/02; F16L 23/12; F16L 23/18

(52) U.S. Cl. CPC F16L 17/02; F16L 23/18; F16L 23/12
USPC 285/95; 285/405; 285/401

(57) ABSTRACT

A mating connection assembly permits quick and efficient connection and disconnection of tubular goods and equipment. A female box-end connection member has a body, a central through-bore, a bowl-like receptacle section having a tapered internal surface and inwardly-extending load shoulder members along the tapered internal surface, grouped in stacks of spaced-apart rows. A mating male pin-end connection member has a body section, a tapered pin extension, a central through-bore and lug members on the outer surface of the tapered pin extension. The tapered pin extension of the male pin-end connection member can be stabbed into the female box-end connection member and partially rotated. When joined in mating relationship, the connection assembly provides a fluid pressure seal, supports high-tensile axial loading and permits the transmission of torque through the connection assembly.

### CROSS REFERENCES TO RELATED APPLICATION

Priority of U.S. Provisional Patent Application Ser. No. 61/595,966, filed Feb. 7, 2012, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to a mating connection assembly for quick and efficient connecting and disconnecting of tubular goods. More particularly, the present invention pertains to a mating connection assembly that permits the rapid connection and disconnection of tubular goods, equipment and accessories used in well operations. More particularly still, the present invention pertains to a mating connection assembly for tubular goods that provides a fluid pressure seal, supports high-tensile axial loading and permits the transmission of torque through said connection assembly.

2. Brief Description of the Prior Art

Equipment used during the drilling and completion of oil and/or gas wells frequently comprise multiple segments or “subs” that are joined together to form a complete assembly. Such individual segments are typically joined using conventional threaded connections. In order to ensure that such threaded connections form fluid seals that can withstand expected fluid pressures, as well as anticipated axial loading and/or torque forces to be encountered, such connections are frequently joined or “made up” at a shop facility or other staging location prior to transportation to a rig or other work site.

Separation of components may be desirable in order to change or replace such components, or to permit access to internal areas of such equipment. However, once on location, it is typically very difficult and time consuming to disconnect and then re-connect the various components of such equipment. Moreover, in many cases, specialized equipment is needed to connect or disconnect such components making such disconnection and re-connection operations expensive, unsafe, inconvenient and/or otherwise difficult to perform, especially at a well site or other remote location.

Thus, there is a need for a mating connection assembly that permits quick and efficient connection and/or disconnection of components or segments of tubular goods and/or equipment, including while such tubular goods or equipment are located on a rig, at a well site or at another remote location. By way of illustration, but not limitation, such equipment can include casing running tools, cement heads and other surface or down-hole equipment used in connection with the drilling, equipping and/or servicing of oil or gas wells. Such connection assembly should permit quick and efficient connection and disconnection of tubular goods, without the need for specialized equipment (such as, for example, bucking machines) or training, and without requiring increased personnel or manpower.

### SUMMARY OF THE INVENTION

Prior art connection assemblies for tubular goods, including so-called “quick connect” assemblies, typically require application of significant torque forces during connection mating operations. Such torque forces can frequently cause galling of threads and can induce undesirable bearing loads between said threads. The present invention does not require the application of significant torque forces which, in addition to other benefits, results in neutral bearing loads on said connection assembly.

The present invention comprises a mating connection assembly that permits quick and efficient connection and/or disconnection of components or segments of tubular goods and/or equipment. The connection assembly of the present invention can be connected and disconnected in virtually any location or environment including, without limitation, while such tubular goods or equipment are present on a rig, at a well site or in some other remote location.

By way of illustration, but not limitation, the mating connection assembly of the present invention can be used with casing running tools, cement heads and other surface or down-hole equipment used for the drilling, equipping and/or servicing of oil or gas wells. Further, the mating connection assembly of the present invention permits quick and efficient connection and disconnection of tubular goods and components, without the need for specialized equipment (such as, for example, bucking machines) or training, or increased personnel or manpower.

In the preferred embodiment, the connection assembly of the present invention comprises a female box-end connection member having a body, a central through bore extending through said body, a bowl-like receptacle section having a tapered internal surface and a plurality of torque lugs disposed on the distal end of said connection member. A plurality of inwardly-extending load shoulder members are disposed along said tapered internal surface of female box end connection member.

Although the number and relative positioning of said load shoulder members can be varied without departing from the scope of the present invention, in the preferred embodiment, said internal load shoulder members are aligned in spaced-apart rows around the circumference of said tapered internal surface. A plurality of circumferential channels are defined between said load shoulder members oriented substantially perpendicular to the longitudinal axis of said female box-end connection member. Said internal load shoulder members are also aligned parallel to the longitudinal axis of said member to form vertical stacks or “columns” along said tapered internal surface, and defining open pathways or channel areas between said stacked shoulder members. Said channel areas are oriented substantially parallel to the longitudinal axis of said female box-end connection member, and perpendicular to said circumferential channels.

The connection assembly of the present invention further comprises a male pin-end connection member having a body section, a tapered pin extension, and a central through bore extending longitudinally through said connection member. A plurality of lug members are disposed on the outer surface of said tapered pin extension and extend radially outward from said surface. Although the particular number and relative positioning of said lug members can be varied without departing from the scope of the present invention, in the preferred embodiment said radially extending lug members are aligned in spaced-apart rows along the outer circumference of pin extension to define horizontal gaps or channels between said lug members. Said lug members are further aligned to form vertical columns along the outer surface of pin extension, defining open pathways or channel areas between said vertically aligned lug members.

At least one elongate lug slot is positioned in said body section of said male pin-end connection member, said at least one elongate lug slot is generally oriented and has sufficient depth to receive a torque lug extending from the distal end of said female box-end connection member when said male pin-end connection member and said female box-end connection member are joined together in mating relationship. A channel is also formed in said body section of said male pin-end connection member, and is oriented between ends of said torque lug slot and substantially parallel to the longitudinal axis of said male pin-end connection member.

A torque block is slidably received within said channel. When retracted, no portion of said torque block extends into said elongate lug slot. When extended, a portion of said torque block extends into elongate lug slot.

When mating of the connection assembly of the present invention is desired, said male pin-end connection member is axially aligned with said female box-end connection member. Stacked lug members of said pin end connection member are positioned in alignment with open channels along the internal surface of said female box-end connection member. The tapered pin extension of male pin-end connection member can then be stabbed into said female box-end connection member.

When said tapered pin extension is fully received within said female box-end connection member, each torque lug of box-end connection member is positioned within an elongate lug slot of said pin-end connection member. Further, the stacked lug members of pin-end connection member are aligned with, and disposed within, circumferential channels formed along the inner surface of said box-end connection member.

Torque forces can then be applied to rotate pin-end connection member about its longitudinal axis, typically a quarter turn in a clock-wise direction, relative to said box-end connection member. Following such rotation, stacked lug members of pin-end connection member remain within said circumferential channels along the inner surface of said box-end connection member, but are brought into axial alignment with stacked load shoulder members of box-end connection member. Further, during such rotation, each torque lug travels laterally within an elongate lug slot. At least one torque block can thereafter be extended and locked into to position to prevent counter-rotation of said connection members.

When joined in mating relationship, said connection assembly of the present invention provides a fluid pressure seal, supports high-tensile axial loading and permits the transmission of torque through said connection assembly. Unlike prior art connection assemblies for tubular goods, the connection assembly of the present invention permits quick and efficient connection and/or disconnection of components or segments of tubular goods and/or equipment, and does not require application of significant torque forces during connection and disconnection operations. Moreover, said connection assembly can be connected and disconnected in virtually any environment including, without limitation, on a rig, at a well site or in other remote locations, and without the need for specialized equipment (such as, for example, bucking machines) or training, or increased personnel or manpower.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side sectional view of the connection assembly of the present invention, shown with its components in mating relationship, incorporated within a representative tool combination.

FIG. 2 depicts a side sectional view of the connection assembly of the present invention, shown with certain components in detached relationship, incorporated within a representative tool combination.

FIG. 3 depicts a side, partial sectional view of the connection assembly of the present invention in mating relationship.

FIG. 4 depicts a side sectional view of a box-end (female) connection member of the connection assembly of the present invention.

FIG. 5 depicts an end view of a box-end (female) connection member of the connection assembly of the present invention.

FIG. 6 depicts a side view of a pin-end (male) connection member of the connection assembly of the present invention.

FIG. 6a depicts a side sectional view of the detail area highlighted in FIG. 6.

FIG. 7 depicts a side view of a pin-end (male) connection member of the connection assembly of the present invention.

FIG. 7a depicts a side sectional view of the detail area highlighted in FIG. 7.

FIG. 8 depicts a perspective view of sliding torque block of the present invention.

FIG. 9 depicts a side view of a sliding torque block of the present invention.

### DETAILED DESCRIPTION OF A PREFERRED EMBODIMENT

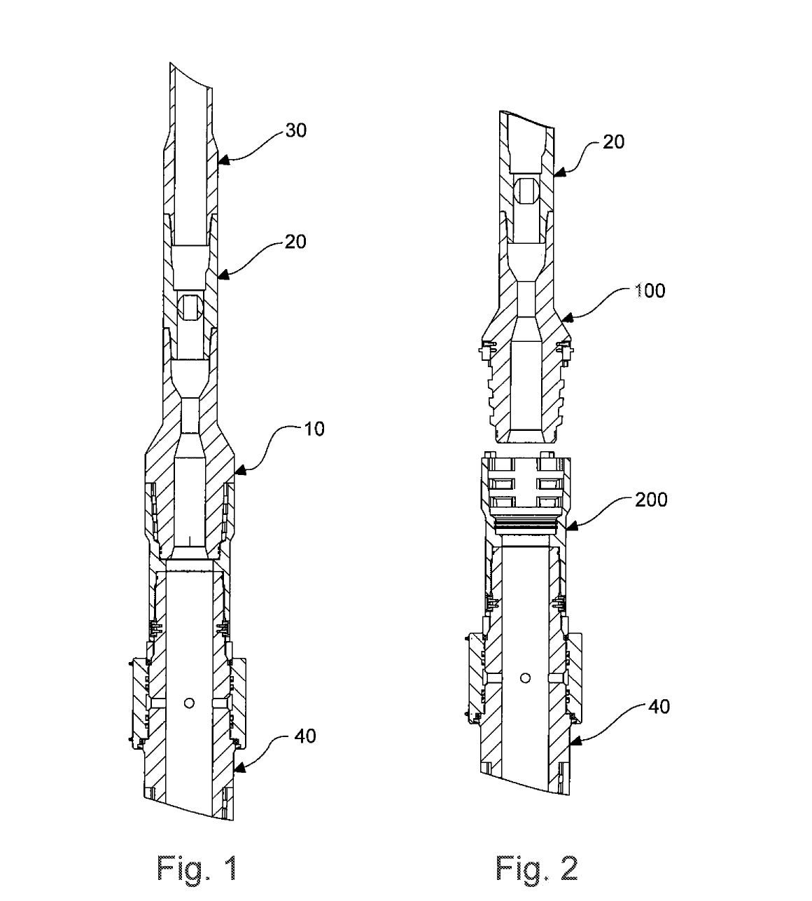

FIG. 1 depicts a side sectional view of connection assembly 10 of the present invention, in mating relationship, incorporated within a representative tool combination comprising top drive quill 30, valve assembly 20 and cement head 40. By way of illustration, but not limitation, it is to be observed that such tool combination, or other variation or combination of tools, may be encountered at or near the rig floor of a drilling rig.

FIG. 2 depicts a side sectional view of connection assembly 10 of the present invention incorporated within a representative tool combination; as depicted in FIG. 2, said connection assembly 10 is in a detached or disconnected relationship. Specifically, as depicted in FIG. 2, male pin-end connection member 100 is disconnected and removed from female box-end connection member 200.

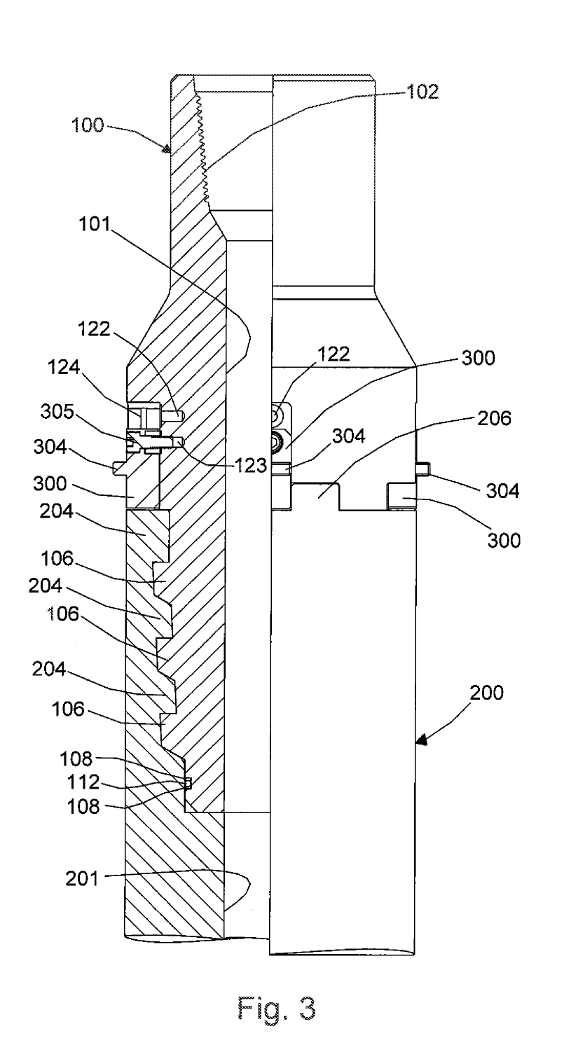

FIG. 3 depicts a side, partial sectional view of a connection assembly of the present invention with male pin-end connection member 100 and female box-end connection member 200 joined in mating relationship. Generally, male pin-end connection member 100 has central through bore 101, as well as inner threaded connection profile 102 (for connection with other components of a tool combination such as, for example, valve assembly 20 shown in FIG. 1). Similarly, female box-end connection member 200 has central through bore 201. In the preferred embodiment, when male pin-end connection member 100 and female box-end connection member 200 are joined together in mating relationship, central through bores 101 and 201 are substantially aligned, providing a central axial flow path through said connection assembly.

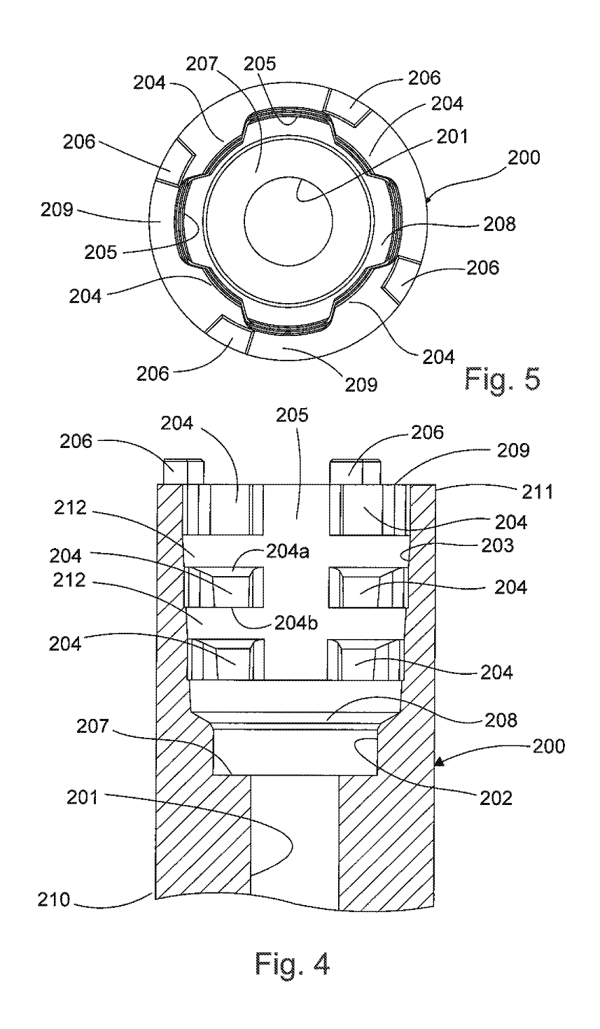

FIG. 4 depicts a side sectional view of female box-end connection member 200 of connection assembly 10 of the present invention having central through bore 201, proximate end 210 and distal end 211. Female box-end connection member 200 further has tapered internal surface 203, lower recess area 202 defining internal contact surface 207, tapered internal shoulder surface 208, and external shoulder surface 209 at distal end 211. A plurality of torque lugs 206 are disposed at said external shoulder surface 209.

A plurality of inwardly-extending internal load shoulder members 204 are disposed along internal surface 203 of female box end connection member 200. It is to be observed that the particular number and relative positioning of said load shoulder members 204 can be varied without departing from the scope of the present invention. However, in the preferred embodiment, said internal load shoulder members 204 each have tapered upper surfaces 204a and substantially flat lower surfaces 204b, and are aligned in spaced-apart rows around internal surface 203. Circumferential channels 212 are defined between said load shoulder members 204; said circumferential channels 212 are oriented substantially perpendicular to the longitudinal axis of said female box-end connection member 200. Further, said internal load shoulder members 204 are also aligned to form vertical stacks or “columns” along internal surface 203, defining open pathways or channel areas 205 between said stacked shoulder members 204. Said channel areas 205 are oriented substantially parallel to the longitudinal axis of said female box-end connection member 200, and perpendicular to circumferential channels 212. In the preferred embodiment, said female box-end connection member has four “stacks” or “columns” of aligned shoulder members 204, phased 90-degrees apart, disposed along internal surface 203.

FIG. 5 depicts an end view of female box-end connection member 200 of connection assembly 10 of the present invention. Female box-end connection member 200 has through bore 201, lower internal contact surface 207, tapered internal shoulder surface 208, and external shoulder surface 209. Torque lugs 206 are disposed on said external shoulder surface 209. Internal load shoulder members 204 are stacked to form spaced-apart vertical columns, with open pathways or channel areas 205 disposed between said vertically aligned shoulder members 204.

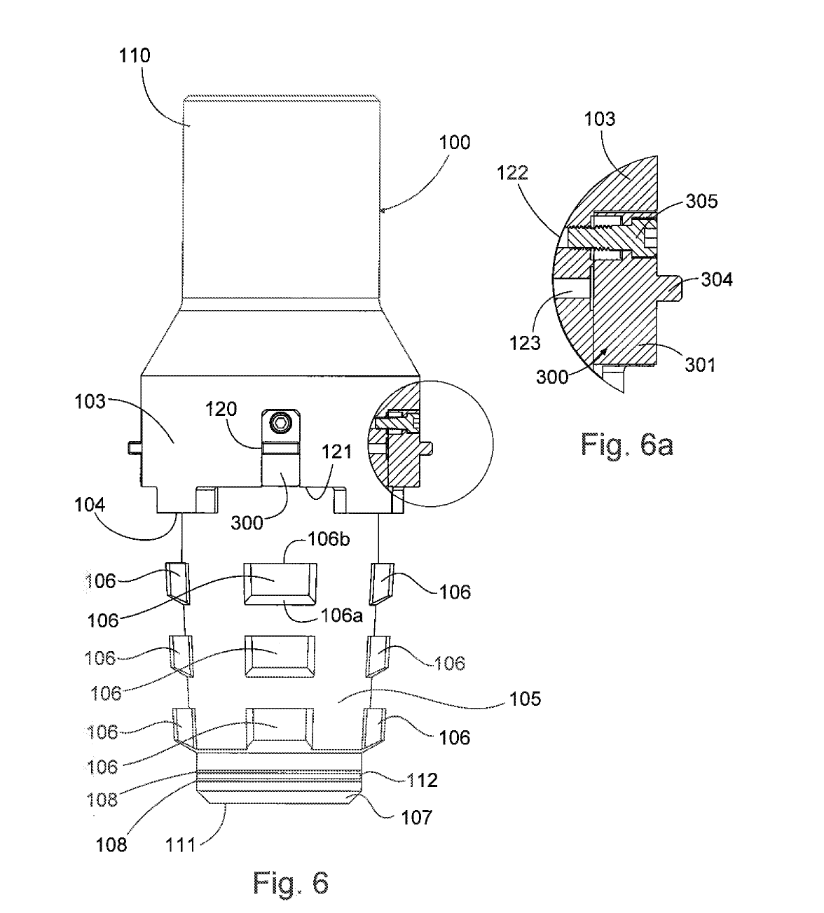

FIG. 6 depicts a side view of a pin-end (male) connection member 100 of connection assembly 10 of the present invention. Male pin-end connection member 100 has a proximate end 110, a distal end 111 and a central through bore 102 (not visible in FIG. 6) extending through said connection member 100. Male pin-end connection member 100 further has body section 103 defining pin shoulder 104, tapered pin extension 105, and a tapered distal contact surface 107 at distal end 111. Elastomeric sealing members 108 (such as, for example, O-rings) are disposed near distal end 111, with back-up ring 112 between said sealing members 108.

A plurality of lug members 106 are disposed on the outer surface of tapered pin extension 105 of male pin-end connection member 100 and extend radially outward from said surface. It is to be observed that the particular number and relative positioning of said lug members 106 can be varied without departing from the scope of the present invention. However, in the preferred embodiment, said radially extending lug members 106 have tapered load heel surface 106a and substantially flat load flank 106b. Said lug members 106 are aligned in spaced-apart rows along the outer circumference of pin extension 105, defining horizontal gaps between said lug member 106. Further, said lug members 106 are also aligned to form vertical columns along the outer surface of pin extension 105, defining open pathways or channel areas 109 between said vertically aligned lug members 106.

Still referring to FIG. 6, elongate lug slot 121 is beneficially disposed along pin shoulder 104 of body section 103; said elongate lug slot 121 is generally oriented and has sufficient depth to receive a torque lug 206 of female box-end connection member 200 depicted in FIG. 5 when male pin-end connection member 100 and female box-end connection member 200 are joined together in mating relationship. Channel 120 is disposed in body section 103 of male pin-end connection member 100. In the preferred embodiment, said channel 120 is oriented substantially parallel to the longitudinal axis of said male pin-end connection member 100, and is positioned at or near the mid-point of elongate lug slot 121.

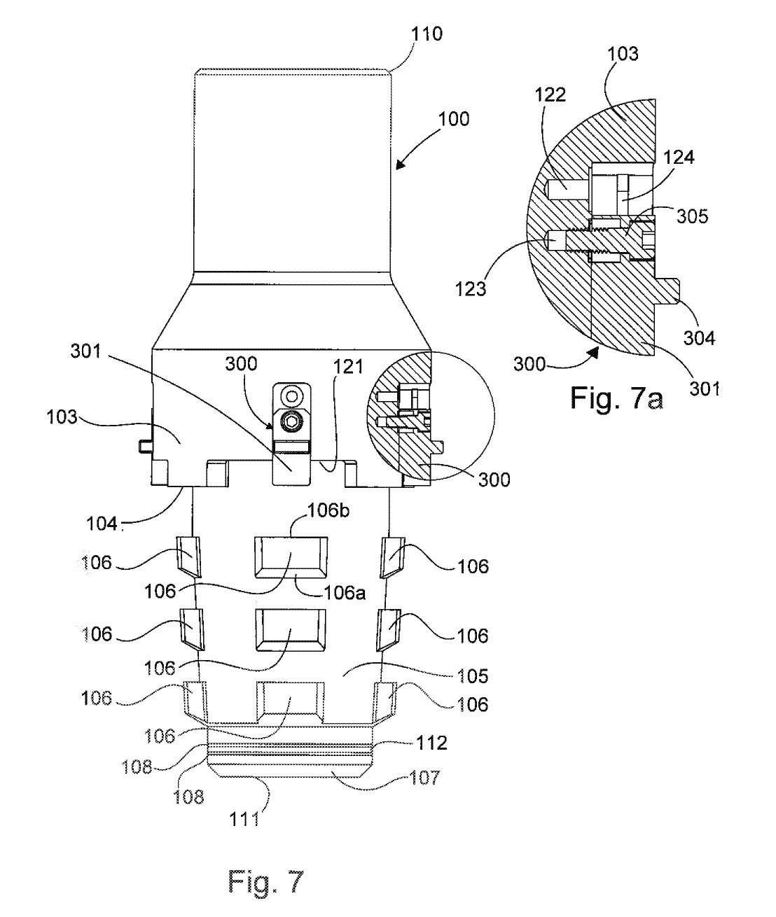

A torque block 300 is slidably disposed within said channel 120. In the view depicted in FIG. 6, sliding torque block 300 is fully received within said channel 120. As such, no portion of said torque block 300 extends into elongate lug slot 121. FIG. 7 depicts an alternative side view of a pin-end (male) connection member 100 of the connection assembly of the present invention wherein said slidable torque block 300 is in an extended position. In the view depicted in FIG. 7, said torque block 300 partially extends into elongate lug slot 121. In the preferred embodiment, the base of said torque block 300 is substantially aligned with pin shoulder 104.

In the preferred embodiment, tapered pin extension 105 has a taper angle of between 3 to 7 degree; such taper angle permits easier stabbing of pin extension 105 into female box-end connection member 200 especially in the event that a supporting drilling rig or other structure is not in complete alignment with casing being installed in a well. Further, lower surface 106a of each lug member 106 can beneficially have the same taper as pin extension 105 to allow for stabbing, while upper surface 106b of each such lug member 106 is substantially flat for supporting axial loading.

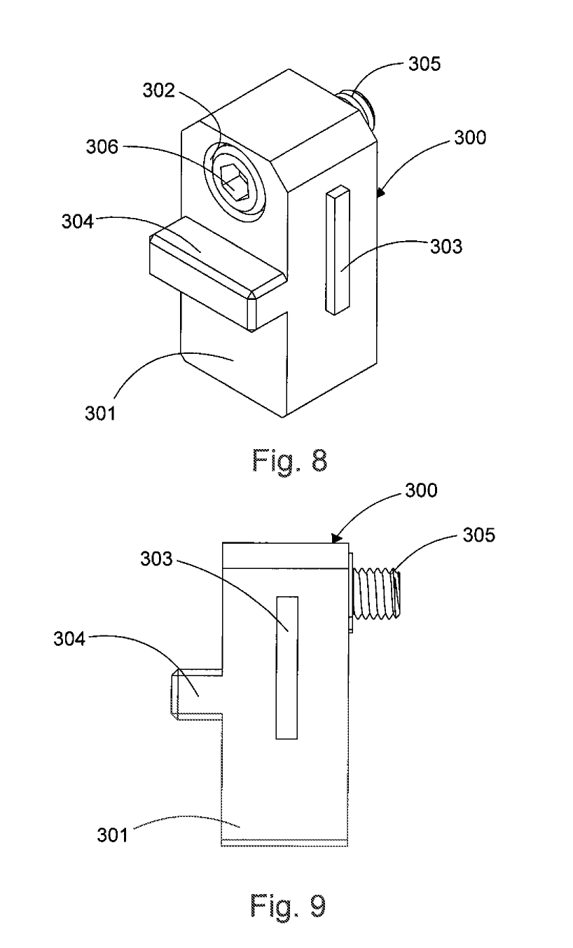

FIG. 8 depicts a perspective view of sliding torque block 300 of the present invention having body section 301, finger tab 304 and side slide key member 303. Transverse threaded bore 302 extends through said body section 301. Threaded bolt 305 (having external threads) and bolt head 306 is threadedly received within threaded bore 302. FIG. 9 depicts a side view of a sliding torque block 300 of the present invention comprising body section 301, finger tab 304, side slide key member 303 and threaded bolt 305 partially extending from threaded bore 302 (not visible in FIG. 9).

Referring back to FIG. 6a, a side sectional view of the detail area highlighted in FIG. 6 is depicted. Sliding torque block 300, slidably disposed within channel 120, is shown in the retracted or disengaged position. In this position, sliding torque block 300 is fully received within said channel 120, and no portion of said torque block 300 extends into elongate lug slot 121. Captured threaded bolt 305 is threadedly engaged in upper threaded bore 122 to lock torque block 300 in place.

FIG. 7a depicts a side sectional view of the detail area highlighted in FIG. 7. Sliding torque block 300, slidably disposed within channel 120, is depicted in the extended or engaged position. In this position, said torque block 300 partially extends into elongate lug slot 121, such that the base of said torque block 300 is substantially aligned with pin shoulder 104. Captured threaded bolt 305 is threadedly engaged in lower threaded bore 123 to lock torque block 300 in place.

In operation, male pin-end connection member 100 is axially aligned with female box-end connection member 200 as depicted in FIG. 2. Specifically, stacked lug members 106 are positioned in alignment with open channels 205 along internal surface 203 of female box-end connection member 200. Tapered pin extension 105 of male pin-end connection member 100 is then stabbed into said female box-end connection member 200; when fully stabbed, distal end 111 of said pin-end connection member is completely received and engaged against internal contact surface 207 of box-end connection member 200. During stabbing, sliding torque block 300 should preferably be in the retracted or disengaged position, and fully received within channel 120 with no portion of said torque block 300 extending into elongate lug slot 121.

When said tapered pin extension 105 is fully received within female box-end connection member 200, pin shoulder 104 of pin-end connection member 100 contacts upper shoulder 209 of box-end connection member 200. Further, each torque lug 206 of box-end connection member 200 is received within an elongate lug slot 121 of pin-end connection member 100. In this position, stacked lug members 106 of pin-end connection member 100 are aligned with and disposed in circumferential channels 212 of box-end connection member 200.

Torque forces are then applied to rotate pin-end connection member 100 about its longitudinal axis, typically in clock-wise direction, relative to box-end connection member 200. It is to be observed that the specific amount of relative rotation of said members can be adjusted for different operational parameters. However, in the preferred embodiment, pin-end connection member 100 is rotated less than one-quarter turn (typically forty-five degrees) relative to box-end connection member 200. Following such rotation, stacked lug members 106 of pin-end connection member 100 remain within circumferential channels 212, but are brought into axial alignment with load shoulder members 204 of box-end connection member 200. Further, during such rotation, torque lugs 206 travel laterally within elongate lug slots 121.

FIG. 3 depicts said male pin-end connection member 100 and female box-end connection member 200 following application of torque forces and relative rotation of said connection members. Referring to FIG. 3, tapered pin extension 105 of male pin-end connection member 100 is fully received within female box-end connection member 200. Pin shoulder 104 of pin-end connection member 100 contacts and engages against upper shoulder 209 of box-end connection member 200. Each torque lug 206 of box-end connection member 200 is received within an elongate lug slot 121 of pin-end connection member 100.

Still referring to FIG. 3, stacked lug members 106 of pin-end connection member 100 are disposed in circumferential channels 212 of box-end connection member 200. Further, following rotation, said stacked lug members 106 of pin-end connection member 100 are in axial alignment with load shoulder members 204 of box-end connection member 200; substantially flat load flank 106b of each lug member 106 is engaged against a substantially flat lower surface 204b of a load shoulder member 204.

Once in this position, captured threaded bolt 305 can be threadedly disengaged (unscrewed) from upper threaded bore 122, and torque block 300 can be moved to the extended position within channel 120. Side slide key members 303 of each sliding torque block 300 are slidably received within an elongate key slot 124 to keep each sliding torque block 300 positioned with channel 120. As depicted in FIG. 3, after a torque block 300 has been shifted, said torque block 300 partially extends into elongate lug slot 121 and engages against a side of a torque lug 206. Captured threaded bolt 305 is threadedly engaged in lower threaded bore 123 to lock torque block 300 in place, thereby preventing lateral movement of torque lug 206 within elongate lug slot 121 (and relative rotation between pin-end connection member 100 and box-end connection member 200).

Elastomer seal members 108 engage against inner surface of lower recess area 202 of female box-end connection member 200 and provide a fluid pressure seal. Such seal prevent fluids (including, without limitation, drilling mud, cement or other fluid) from flowing through the interface between pin-end connection member 100 and box-end connection member 200.

When joined in mating relationship (as depicted in FIG. 3), connection assembly 10 of present invention provides a fluid pressure seal, supports high-tensile axial loading and permits the transmission of torque through said connection assembly 10. Unlike prior art connection assemblies for tubular goods, connection assembly 10 of the present invention permits quick and efficient connection and/or disconnection of components or segments of tubular goods and/or equipment, and does not require application of significant torque forces during such connection and disconnection operations. Moreover, connection assembly 10 can be connected and disconnected in virtually any location or environment including, without limitation, on a rig, at a well site or in other remote locations, and without the need for specialized equipment (such as, for example, bucking machines) or training, or increased personnel or manpower.

When decoupling of connection assembly 10 of the present invention is desired, captured threaded bolt 305 can be threadedly disengaged (unscrewed) from lower threaded bore 123, and torque block 300 can be moved to the retracted position within channel 120. After torque block 300 has been shifted, said torque block 300 no longer extends into elongate lug slot 121 or engages against torque lug 206. As such, lateral movement of torque lug 206 is possible within elongate lug slot 121, as well as relative rotation between pin-end connection member 100 and box-end connection member 200. Captured threaded bolt 305 can be threadedly engaged in upper threaded bore 122 to lock torque block 300 in place.

Torque forces are then applied to rotate pin-end connection member 100 about its longitudinal axis, typically in a counter-clockwise direction, relative to box-end connection member 200. As noted above, in the preferred embodiment, pin-end connection member 100 is rotated approximately less than one-quarter turn (typically forty-five degrees) relative to box-end connection member 200. Following such rotation, stacked lug members 106 of pin-end connection member 100 remain within circumferential channels 212, but are brought out of axial alignment with load shoulder members 204 of box-end connection member 200. Torque lugs 206 also travel laterally within elongate lug slots 121.

Following such rotation, stacked lug members 106 of male pin-end connection member 100 are positioned in alignment with open channels 205 along internal surface 203 of female box-end connection member 200. Once in this position, tapered pin extension 105 of male pin-end connection member 100 can be axially removed from said female box-end connection member 200, permitting separation of said male pin-end connection member 100 from said female box-end connection member 200.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A connection assembly comprising:
a) a box end connection member comprising:
i) a body having a distal end, a proximate end, a central through bore extending from said distal end to said proximate end defining an internal contact surface; and
ii) a plurality of load shoulder members extending from said internal contact surface, wherein said load shoulder members are spaced to define at least one channel oriented substantially perpendicular to the longitudinal axis of said central through bore and at least one channel oriented substantially parallel to said longitudinal axis;
b) a pin end connection member, adapted to be partially received within said box end connection member, comprising:
i) a substantially tubular body having a distal end, a proximate end, through bore extending from distal end to said proximate end, a pin shoulder, and a pin extension having an outer surface;
ii) at least one lug member disposed on said outer surface of said pin extension; and
c) means for preventing rotation of said box end and pin end connection members relative to each other.

2. The connection assembly of claim 1, wherein said means for preventing rotation of said box end and pin end connection members relative to each other comprises:
a) at least one torque lug disposed at said distal end of said box end connection member;
b) at least one elongate slot disposed in said pin shoulder for receiving said at least one torque lug; and
c) means for selectively locking said at least one torque lug against movement within said at least one elongate slot.

3. The connection assembly of claim 2, wherein said means for selectively locking said at least one torque lug against movement within said at least one elongate slot further comprises:
a) a channel in said body of said pin end connection member, wherein said channel is positioned along the length of said at least one elongate slot, oriented substantially perpendicular to said elongate slot and has first and second threaded bores extending into said body;
b) a torque block slideably disposed within said channel having a transverse bore extending through said block; and
c) a threaded bolt disposed through said transverse bore.

4. The connection assembly of claim 1, wherein said load shoulder members have a tapered surface facing said distal end of said box end connection member and a substantially flat surface facing said proximate end of said box end connection member.

5. The connection assembly of claim 1, wherein said at least one lug member has a tapered surface facing said distal end of said pin end connection member and a substantially flat surface facing said proximate end of said pin end connection member.

6. The connection assembly of claim 1, further comprising a fluid pressure seal between said pin end connection member and said box end connection member.

7. The connection assembly of claim 6, wherein said fluid pressure seal comprises at least one elastomer seal disposed around said pin extension.

8. A connection assembly comprising:
a) a box end connection member comprising:
i) a body having a distal end, a proximate end, a central through bore extending from said distal end to said proximate end defining an internal contact surface;
ii) a plurality of load shoulder members extending from said internal contact surface, wherein said load shoulder members are spaced to define at least one channel oriented substantially perpendicular to the longitudinal axis of said central through bore and at least one channel oriented substantially parallel to said longitudinal axis;
iii) at least one torque lug disposed at said distal end;
b) a pin end connection member, adapted to be partially received within said box end connection member, comprising:
i) a substantially tubular body having a distal end, a proximate end, a through bore extending from said distal end to said proximate end, a pin shoulder defining at least one elongate slot for receiving said at least one torque lug, and a pin extension having an outer surface;
ii) at least one lug member disposed on said outer surface of said pin extension;
c) a channel in said body of said pin end connection member, wherein said channel is positioned along the length of said at least one elongate slot, oriented substantially perpendicular to said elongate slot and has first and second threaded bores extending into said body;
d) a torque block slideably disposed within said channel having a transverse bore extending through said block; and
e) a threaded bolt disposed through said transverse bore.

9. The connection assembly of claim 8, wherein said load shoulder members have a tapered surface facing said distal end of said box end connection member and a substantially flat surface facing said proximate end of said box end connection member.

10. The connection assembly of claim 8, wherein said at least one lug member has a tapered surface facing said distal end of said pin end connection member and a substantially flat surface facing said proximate end of said pin end connection member.

11. The connection assembly of claim 8, further comprising a fluid pressure seal between said pin end connection member and said box end connection member.

12. The connection assembly of claim 11, wherein said fluid pressure seal comprises at least one elastomer seal disposed around said pin extension.

13. A connection assembly comprising:
a) a box end connection member comprising:
i) a body having a distal end, a proximate end, a central through bore extending from said distal end to said proximate end defining an internal contact surface;
ii) a plurality of load shoulder members extending from said internal contact surface, wherein said load shoulder members are arranged in at least one spaced-apart column substantially parallel to the longitudinal axis of said central through bore, and define at least one channel oriented substantially perpendicular to said longitudinal axis and at least one channel oriented substantially parallel to said longitudinal axis;
iii) at least one torque lug disposed at said distal end;
b) a pin end connection member, adapted to be partially received within said box end connection member, comprising:
i) a substantially tubular body having a distal end, a proximate end, a through bore extending from said distal end to said proximate end, a pin shoulder defining at least one elongate slot for receiving said at least one torque lug, and a pin extension having an outer surface;
ii) a plurality of lug members disposed on said outer surface of said pin extension;
c) a channel in said body of said pin end connection member, wherein said channel is positioned along the length of said at least one elongate slot, oriented substantially perpendicular to said elongate slot and has first and second threaded bores extending into said body;
d) a torque block slideably disposed within said channel having a transverse bore extending through said block; and
e) a threaded bolt disposed through said transverse bore.

14. The connection assembly of claim 13, wherein said plurality of lug members are arranged in at least one spaced-apart column substantially parallel to the longitudinal axis of said pin extension.

15. The connection assembly of claim 13, wherein said load shoulder members are arranged in four spaced-apart columns phased about every ninety degrees around said internal contact surface.

16. The connection assembly of claim 13, wherein said load shoulder members have a tapered surface facing said distal end of said box end connection member and a substantially flat surface facing said proximate end of said box end connection member.

17. The connection assembly of claim 13, wherein said at least one lug member has a tapered surface facing said distal end of said pin end connection member and a substantially flat surface facing said proximate end of said pin end connection member.

18. The connection assembly of claim 13, further comprising a fluid pressure seal between said pin end connection member and said box end connection member.

19. The connection assembly of claim 18, wherein said fluid pressure seal comprises at least one elastomer seal disposed around said pin extension.
